(19) United States
(12) Patent Application Publication
(10) Pub. No.: US 2026/0368048 A1
(43) Pub. Date: Nov. 19, 2026

(54) MANAGING FAILOVER IN A DISTRIBUTED DATA STORAGE SYSTEM THAT INCLUDES A PLURALITY OF STORAGE UNITS

(71) Applicant: Microsoft Technology Licensing, LLC, Redmond, WA (US)

(72) Inventors: Per Mikael HORAL, Sammamish, WA (US); Hari Sudan SUNDAR, Sammamish, WA (US); Joshua ROWE, Bellevue, WA (US)

(21) Appl. No.: 19/211,213

(22) Filed: May 18, 2025

(51) Int. Cl. G06F 11/20; G06F 11/16

(52) U.S. Cl. CPC G06F 11/2069; G06F 11/1658; G06F 11/2092

(57) ABSTRACT

Methods, apparatuses, and products for managing failover in a distributed data storage system comprising a plurality of storage units, including: maintaining, for a storage unit within the distributed data storage system, a replicated state machine maintained across a plurality of replica instances, wherein the replicated state machine designates a write replica responsible for accepting write operations; in response to detecting a failure condition for the storage unit, applying a state transition in the replicated state machine to designate a new write replica, wherein the new write replica resides in a replica instance determined to be an eligible replica instance; and enabling write operations directed to the storage unit to be serviced by the new write replica following application of the state transition.

### BACKGROUND

A distributed database system may be deployed across multiple geographic regions to improve data availability, reduce latency, and increase fault tolerance. The distributed database system typically divides data into independent partitions and replicates each partition across multiple locations to tolerate localized failures and maintain operational continuity. As the scale and complexity of the distributed database system increase, managing the availability and consistency of replicated data across partitions and regions presents a range of operational challenges.

The distributed database system may encounter failures that affect individual partitions, specific geographic regions, or communication paths between system components. These failures may be observable through internal monitoring data, external client behavior, or both. Maintaining availability in the presence of such failures may require evaluating replica status, responding to system-level changes, and reconciling differences between internal system state and client-experienced behavior, while continuing to operate across geographically dispersed infrastructure.

### SUMMARY

According to embodiments of the present disclosure, various methods, apparatus, and products for managing failover in a distributed data storage system comprising a plurality of storage units are described herein. In some aspects, managing failover in a distributed data storage system comprising a plurality of storage units includes: maintaining, for a storage unit within the distributed data storage system, a replicated state machine maintained across a plurality of replica instances, wherein the replicated state machine designates a write replica responsible for accepting write operations; in response to detecting a failure condition for the storage unit, applying a state transition in the replicated state machine to designate a new write replica, wherein the new write replica resides in a replica instance determined to be an eligible replica instance; and enabling write operations directed to the storage unit to be serviced by the new write replica following application of the state transition. In some aspects, an apparatus may include a memory and one or more processing devices, operatively coupled to the memory, where the one or more processing devices are configured to perform similar steps. In some aspects, a computer program product comprising a computer readable storage medium may store computer program instructions that, when executed, perform similar steps.

### BRIEF DESCRIPTION OF DRAWINGS

FIG. 1 sets forth a block diagram of a distributed data storage system 102 in accordance with some embodiments of the present disclosure.

FIG. 2 sets forth a flowchart illustrating an example method of managing failover in a distributed data storage system that includes a plurality of storage units in accordance with some embodiments of the present disclosure.

FIG. 3 sets forth a flowchart illustrating an additional example method of managing failover in a distributed data storage system that includes a plurality of storage units in accordance with some embodiments of the present disclosure.

FIG. 4 sets forth a flowchart illustrating an additional example method of managing failover in a distributed data storage system that includes a plurality of storage units in accordance with some embodiments of the present disclosure.

FIG. 5 sets forth a flowchart illustrating an additional example method of managing failover in a distributed data storage system that includes a plurality of storage units in accordance with some embodiments of the present disclosure.

FIG. 6 sets forth a flowchart illustrating an additional example method of managing failover in a distributed data storage system that includes a plurality of storage units in accordance with some embodiments of the present disclosure.

FIG. 7 sets forth an example of a computing device in accordance with some embodiments of the present disclosure.

FIG. 8 sets forth a block diagram of a cloud service provider service architecture in accordance with some embodiments of the present disclosure.

### DESCRIPTION OF EMBODIMENTS

Embodiments described in the present disclosure relate to a distributed database system that is capable of maintaining operational availability in the presence of localized failures, as well as maintaining operational availability even for full regional-scale outages (or even beyond a single region depending on user configuration). The distributed database system can store data across multiple geographic regions and divide the data into independently managed storage units. A failure affecting a single storage unit could potentially interrupt write operations for a specific subset of the data, even when other portions of the distributed database system continue to operate normally. In the embodiments described herein, however, independent failover for each storage unit is enabled to improve fault isolation and reduce the impact of failures on overall performance.

In some embodiments, each storage unit participates in its own recovery process without requiring coordination from a centralized service (i.e., independent failover). Recovery actions can be scoped to the specific storage unit that experienced the failure, such that faster recovery times can be experienced and the likelihood of service disruption affecting unrelated portions of the distributed database system can be reduced.

In some embodiments, the distributed database system can associate each storage unit with a state-based decision process that selects the region used for write operations. This state-based decision process can follow a predefined set of transitions to guide failover behavior. In some embodiments, the distributed database system selects a new write location based on a configured region policy and ensures that all replicas of the storage unit converge on the same outcome, such that failover does not rely on a centralized controller.

The distributed database system described herein can be configured to detect failures using a combination of internal signals and external observations. Internal signals can include replica unavailability or delays in communication. External observations can reflect changes in client activity, such as repeated request failures or traffic disappearance. Upon detecting a failure, the distributed database system can select a new write location for the affected storage unit. This selection can depend on the availability of responsive replicas and can follow preconfigured region preferences. Because the selection is scoped to a single storage unit, the distributed database system can avoid unnecessary region-wide failovers and maintain availability for unaffected data.

In some embodiments, client systems are configured to detect that a write location has changed and reroute requests to the updated location. The distributed database system can support this behavior by providing access to updated location information without requiring centralized coordination. As a result, clients can continue operations with minimal interruption and improved responsiveness. This improved continuity of write operations during failure conditions can help reduce service downtime and maintain the availability of user-facing applications that rely on the distributed database system. This can result in fewer support incidents, improved user experience, and higher levels of customer satisfaction. In some embodiments, the ability to provide uninterrupted data access under partial failure conditions can support stronger service level guarantees and enable differentiated offerings, which can contribute to revenue growth and improved operational efficiency.

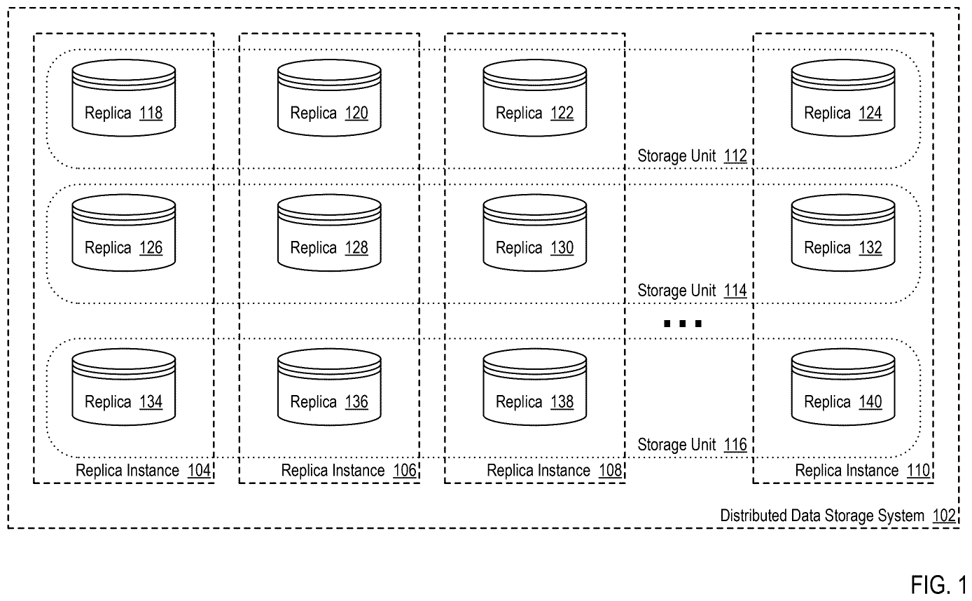

For further explanation, FIG. 1 sets forth a block diagram of a distributed data storage system 102 in accordance with some embodiments of the present disclosure. A distributed data storage system 102 is a computing system configured to persist and manage data across multiple independent computing resources that are separated by physical or logical boundaries. The distributed data storage system 102 is distributed in the sense that data is not stored in a single location, but instead partitioned or replicated across multiple locations to increase durability, availability, and resilience to failure. In some embodiments, the distributed data storage system 102 may span different regions of a cloud provider, separate data centers, distinct availability zones within a single region, or otherwise span multiple failure domains. In other embodiments, the distributed data storage system 102 may be deployed across a cluster of machines within a single facility, where failures are isolated at the rack, power domain, or network segment level. Examples of distributed data storage systems include distributed databases, distributed file systems, object stores, replicated key-value stores, and so on. Examples of distributed data storage systems 102 include Cosmos DB, Apache Cassandra, Amazon DynamoDB, Google Spanner, and others.

The distributed data storage system 102 depicted in FIG. 1 includes a plurality of replica instances 104, 106, 108, 110. A replica instance may be embodied, for example, as a computing process or node that stores a copy of one or more portions of the distributed data storage system's 102 data. Each replica instance 104, 106, 108, 110 may be capable of participating in read or write operations directed to the distributed data storage system 102, although at a given point in time only one replica instance 104, 106, 108, 110 may actively be supporting write activity for a given storage unit, as will be described in greater detail below. Each replica instance may be responsible for managing a set of local resources, including storage, memory, network connections, and so on. In various embodiments, replica instances 104, 106, 108, 110 may be distributed across distinct geographic regions, availability zones, or fault domains to reduce the likelihood of correlated failure. A replica instance 104, 106, 108, 110 may operate independently or as part of a coordinated group, depending on its role and the configuration of the distributed data storage system 102.

The distributed data storage system 102 depicted in FIG. 1 is used to store a plurality of storage units 112, 114, 116. A storage unit 112, 114, 116 can be a logical subdivision of the overall dataset managed by the distributed data storage system 102. In some embodiments, a storage unit 112, 114, 116 corresponds to a partition, shard, or range of data items, such as a subset of keys in a key-value store or a set of rows in a distributed table. In other embodiments, a storage unit 112, 114, 116 may be defined by size, workload characteristics, or application-level grouping. Storage units 112, 114, 116 enable scalable data access and isolation of failure domains by allowing different portions of the dataset to be managed independently. The number and arrangement of storage units 112, 114, 116 may be static or dynamic, and may be determined by configuration parameters, operational metrics, or data placement algorithms. In the example depicted in FIG. 1, each of the storage units 112, 114, 116 spans multiple replica instances 104, 106, 108, 110.

Each storage unit 112, 114, 116 depicted in FIG. 1 includes multiple replicas 118, 120, 122, 124, 126, 128, 130, 132, 134, 136, 138, 140. Each replica may be embodied, for example, as a persistent copy of the data associated with a storage unit, maintained to improve availability and consistency across the distributed data storage system 102. Replicas may be configured to operate in different roles, such as write replicas that accept client write operations, or read replicas that serve read-only requests. In some embodiments, one replica of a storage unit is designated as the primary or write leader, while others act as secondaries or followers. Replicas of a given storage unit 112, 114, 116 may be stored on separate replica instances 104, 106, 108, 110, and may be placed in different failure domains for redundancy. The number of replicas per storage unit 112, 114, 116 and the assignment of roles to those replicas may be determined based on system policies, data durability requirements, observed system conditions, or in some other way. In various embodiments, replicas may use different replication mechanisms, such as asynchronous replication, quorum-based updates, state machine coordination, or some other mechanism to stay consistent with one another.

Clients can interact with the distributed data storage system 102 by issuing requests to read from or write to one or more storage units. These requests may be directed to a service end-point or routed through an SDK or proxy layer that is aware of the current replica topology. On the backend, the distributed data storage system 102 determines which replica instance should handle each request, based on replica roles, consistency requirements, and routing metadata. In some embodiments, the distributed data storage system 102 automatically retries or redirects requests in the event of failures, for example, using cached information to select alternative replicas. Write requests are processed by the replica designated as the current write replica for the target storage unit, while read requests may be served by any suitable replica depending on configuration settings.

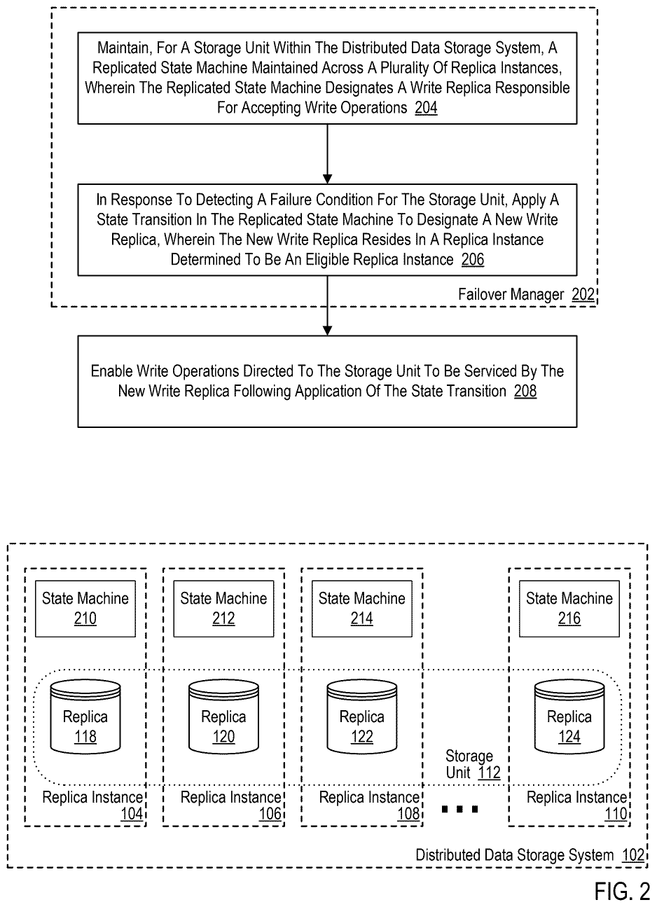

For further explanation, FIG. 2 sets forth a flowchart illustrating an example method of managing failover in a distributed data storage system 102 that includes a plurality of storage units 112, 114, 116. The distributed data storage system 102 of FIG. 2 may be similar to the distributed data storage system 102 depicted in FIG. 1 and described above, although the example of FIG. 2 includes only a single storage unit 112 for ease of illustration.

The example method depicted in FIG. 2 includes a failover manager 202. The failover manager 202 may be implemented as a dedicated system component, such as a distributed coordination service, a background process running on each replica instance, a control plane element, or in some other way. In some embodiments, the failover manager 202 monitors the health and responsiveness of storage units and their corresponding replicas. The failover manager 202 may analyze metrics such as, for example, request success rates, replica heartbeats, quorum status, application-layer errors, or other information to detect failure conditions. The failover manager 202 may operate in a centralized, decentralized, or federated manner, depending on the architecture of the distributed data storage system 102. The failover manager 202 can be responsible for determining when a failover should occur and for initiating the process of transferring write authority from one replica to another.

The example method depicted in FIG. 2 includes maintaining 204, for a storage unit 112 within the distributed data storage system 102, a replicated state machine 210, 212, 214, 216 that is maintained across a plurality of replica instances 104, 106, 108, 110. The replicated state machine 210, 212, 214, 216 of FIG. 2 can designate a write replica 118, 120, 122, 124 responsible for accepting write operations that are directed to the storage unit 112. The replicated state machine can define the current configuration of write authority for the storage unit 112, including which replica is designated as the write replica 118, 120, 122, 124. Each replica instance can maintain a synchronized copy of the replicated state machine and can apply state transitions in a coordinated fashion. In some embodiments, state machine transitions are committed through a consensus protocol such as CAS Paxos, and are written durably to a shared replicated metadata store or other appropriate data store. The replicated state machine may enforce rules that prevent conflicting assignments, enforce quorum constraints, or serialize concurrent failover attempts. The designation of a write replica ensures that all write operations are directed to a single authoritative source, maintaining consistency across all replicas of the storage unit 112.

The example method depicted in FIG. 2 also includes, in response to detecting a failure condition for the storage unit 112, applying 206 a state transition in the replicated state machine to designate a new write replica. In this example, the new write replica can reside in a replica instance determined to be an eligible replica instance. The failure condition may arise, for example, from replica unavailability, communication timeouts, degraded performance, external signals (e.g., application-level failures), or in some other way. Upon determining that the currently assigned write replica is no longer eligible, the failover manager 202 can initiate a transition in the distributed state machine to reassign write authority to a different replica. In this example, the new write replica resides in a replica instance 104, 106, 108, or 110 that is determined to be an eligible replica instance. The selection of the new write replica may take into account region health, replica lag, quorum availability, priority policies, or other relevant factors. The process of applying the state transition may include proposing the change, validating eligibility constraints, and committing the new state to ensure agreement across all participating replicas.

Readers will appreciate that although the preceding paragraph (and other portions of the present disclosure) describe a “failure condition for the storage unit,” a failure in the storage unit is just one of many possible failure cases that can cause a state transition (or other action described herein). For example, some network-related condition (e.g., link failure, congestion) may serve as the triggering event for a state transition. Likewise, an individual replica may fail and may result in a state transition. Furthermore, a compute node (i.e., replica instance) may fail and cause a state transition. Readers will appreciate that any event or similar event may be viewed as a “failure condition for the storage unit” in the present disclosure. In fact, even planned rotations, upgrades, or other planned event that results in a state transition may be viewed as a “failure condition for the storage unit” in the present disclosure. Any event that causes a state transition can serve as a “failure condition for the storage unit” in the present disclosure.

The example method depicted in FIG. 2 also includes enabling 208 write operations directed to the storage unit 112 to be serviced by the new write replica following application of the state transition. Once the new write replica has been designated, the distributed data storage system 102 allows subsequent write requests to be processed by that replica. In some embodiments, client systems become aware of the change through a routing update, request retry behavior, internal partition map refresh, or in some other way. In other embodiments, replicas that are no longer designated as the write replica may forward incoming writes to the newly assigned replica, depending on system configuration. The distributed data storage system 102 thereby resumes write availability for the storage unit 112 without requiring centralized coordination, global metadata updates, or manual intervention.

Consider an example in which replica 118 is initially designated as the write replica by as reflected in the current state of the distributed state machine. In this example, assume that replica 118 initially receives and processes client write operations as the authoritative replica. During operation, however, assume that as the failover manager 202 monitors the health the distributed data storage system 102, replica 118 fails to respond to heartbeat signals within a configured timeout window (or otherwise begins exhibiting degraded performance or elevated error rates). In this example, the failover manager 202 may determine that a failure condition has occurred. In response, the failover manager 202 can initiate a state transition in the replicated state machine to reassign write authority to another eligible replica. The transition may be recorded, for example, using a consensus protocol such as CAS Paxos, which ensures that all participating replicas agree on the new state and that the update is durably persisted. In this example, assume that the failover manager 202 selects replica 124, hosted by replica instance 110, as the new write replica. After the state transition is committed, replica 124 can begin accepting write operations for the storage unit 112. A client that was previously directing write operations to replica 118 may receive a failure response or retryable error. Upon retry, the client may be redirected or may re-resolve routing information, ultimately resulting in its requests being routed to replica 124. The failover thus completes without requiring centralized orchestration, and write availability is maintained in spite of the failure at replica instance 104.

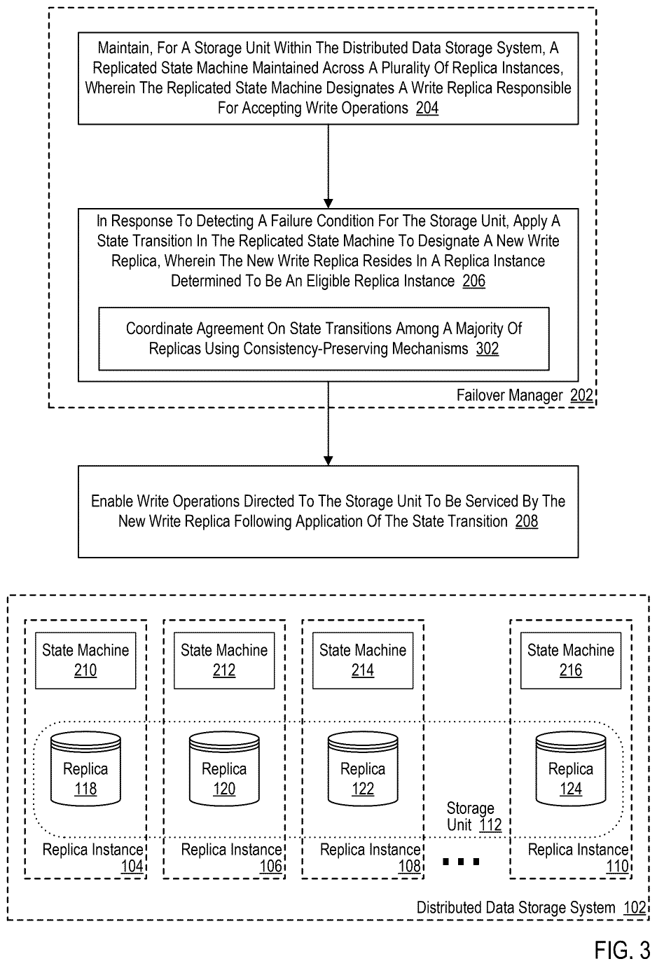

For further explanation, FIG. 3 sets forth a flowchart illustrating an additional example method of managing failover in a distributed data storage system 102 that includes a plurality of storage units 112, 114, 116. In the example method depicted in FIG. 3, applying 206 a state transition in the replicated state machine to designate a new write replica includes coordinating 302, by the failover manager 202, agreement on state transitions among a majority of replicas 118, 120, 122, 124 using consistency-preserving mechanisms. Coordinating 302 agreement on state transitions among a majority of replicas 118, 120, 122, 124 using consistency-preserving mechanisms can be carried out, for example, by the failover manager 202 identifying a candidate replica to become the new write replica. The failover manager 202 can subsequently generate a proposal that specifies the candidate replica 118, 120, 122, 124 and a proposed transition. This proposal can be transmitted to a group of replicas 118, 120, 122, 124 that participate in maintaining the replicated state machine 210, 212, 214, 216 for the relevant storage unit 112. Each replica 118, 120, 122, 124 that receives the proposal can evaluate the proposal against its current state (as reflected in the distributed state machine). If the proposal is valid and does not conflict with a previously accepted state transition, the replica 118, 120, 122, 124 can return a response indicating acceptance. If the proposal is stale, conflicts with a pending or committed transition, or is unacceptable for any other reason, the replica 118, 120, 122, 124 may reject the proposal. When responses have been received from a majority of the replicas 118, 120, 122, 124, the failover manager 202 can treat the proposal as accepted and proceed to commit the transition. Committing the transition (which will be described in more detail below) may include writing the new state to a replicated metadata store, broadcasting the final decision to participating replica instances, marking the designated replica as active in a local routing table, or otherwise committing the transition.

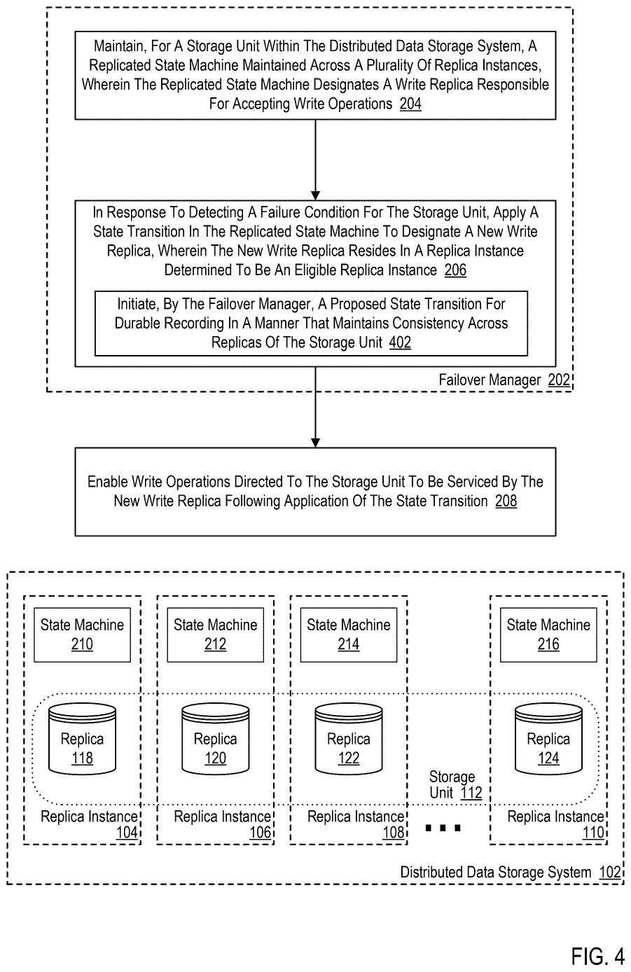

For further explanation, FIG. 4 sets forth a flowchart illustrating an additional example method of managing failover in a distributed data storage system 102 that includes a plurality of storage units 112, 114, 116. In the example method depicted in FIG. 4, applying 206 a state transition in the replicated state machine to designate a new write replica includes initiating 402, by the failover manager 202, a proposed state transition for durable recording in a manner that maintains consistency across replicas of the storage unit 112. Initiating 402 a proposed state transition for durable recording in a manner that maintains consistency across replicas of the storage unit 112 may be carried out, for example, by the failover manager 202 generating a transition proposal that identifies the candidate replica to be designated as the new write replica. The transition proposal can include a proposed transition number, timestamp, or some other marker to establish ordering with respect to prior transitions.

The failover manager 202 can transmit the transition proposal to a set of replica instances 104, 106, 108, 110 that participate in maintaining the replicated state machine 210, 212, 214, 216 for the storage unit 112. Each replica instance 104, 106, 108, 110 that receives the transition proposal can evaluate the proposal against its local copy of the replicated state machine to determine whether the proposed transition is valid. This evaluation can include determining whether the proposal conflicts with any prior transitions that have already been accepted or committed. If the proposal is accepted by the replica instance, the proposal can be durably recorded in a local or shared metadata store using a consistency preserving mechanism, such as a compare and swap operation, a conditional write, or similar mechanism. In some embodiments, recording the proposal may require the replica instance to verify that no other conflicting transition has been recorded since the proposal was received. The proposed transition may be considered committed only after a consistency condition has been satisfied, such as receipt of acknowledgments from a majority of replica instances or confirmation that the proposal has been accepted without conflict. Once the transition has been committed, all participating replica instances can update their copy of the replicated state machine to reflect the new write replica assignment.

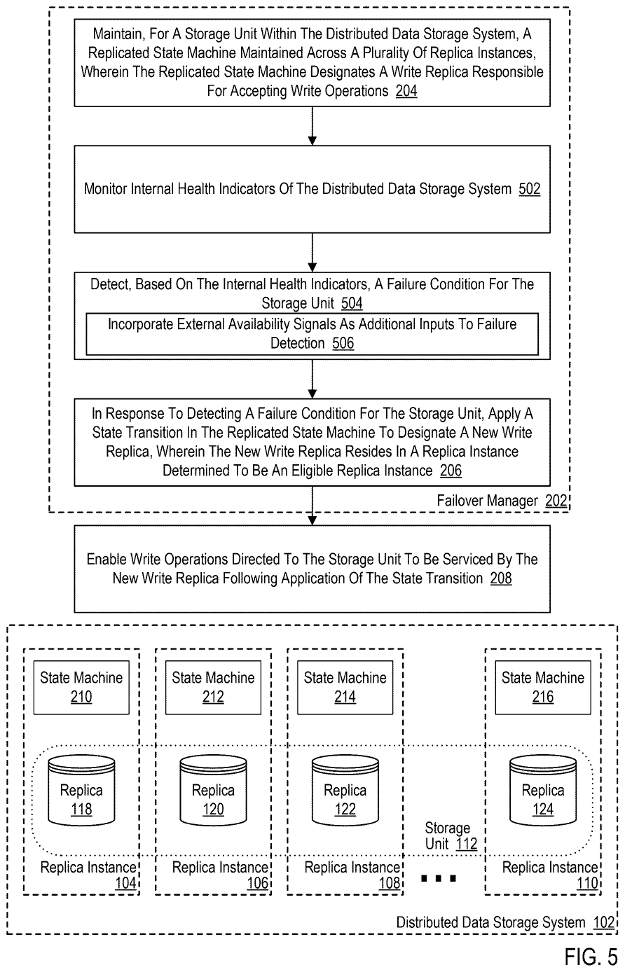

For further explanation, FIG. 5 sets forth a flowchart illustrating an additional example method of managing failover in a distributed data storage system 102 that includes a plurality of storage units 112, 114, 116. The example method depicted in FIG. 5 also includes monitoring 502 internal health indicators of the distributed data storage system 102. Monitoring 502 internal health indicators of the distributed data storage system 102 may be carried out, for example, by the failover manager 202 collecting (or even receiving) replica-specific telemetry such as request success rates, heartbeat messages, operation latencies, error codes, or other metrics that reflect the health or responsiveness of one or more replica instances 104, 106, 108, 110. In some embodiments, the internal health indicators may be received through a monitoring framework that aggregates system-level metrics from across the distributed data storage system 102. In other embodiments, the replica instances may expose local health information directly to the failover manager 202 (or to some other service that performs health analysis). The particular health indicators that are monitored may vary depending on deployment conditions, operational policies, or the failure detection mechanisms in use. Examples of such internal health indicators can include missed heartbeat messages, failure to acknowledge replication progress, elevated request latency, increased error rates, absence of recent successful operations, and so on. In some embodiments, internal health indicators may also include metrics related to resource usage, such as memory pressure, disk saturation, and others.

The example method depicted in FIG. 5 also includes detecting 504, based on the internal health indicators, a failure condition for the storage unit 112. Detecting 504 a failure condition for the storage unit 112 based on the internal health indicators may be carried out, for example, by the failover manager 202 analyzing collected telemetry to determine that one or more replica instances supporting the storage unit 112 are unresponsive, degraded, or otherwise unavailable. In some embodiments, the failure condition may correspond to a replica instance that fails to emit heartbeat messages for a configured time window. In other embodiments, the failure condition may correspond to a pattern of elevated error responses, persistently high operation latency for requests directed to the storage unit 112, or some other pattern of behavior. The determination of a failure condition may take into account one or more threshold values, rate limits, statistical trends over time, or other conditions.

In some embodiments, detecting 504 a failure condition for the storage unit 112 can include incorporating 506 external availability signals as additional inputs to failure detection. Incorporating 506 external availability signals as additional inputs to failure detection may be carried out, for example, by the failover manager 202 receiving, analyzing, or responding to signals that originate outside the distributed data storage system 102. In some embodiments, external availability signals may include client-observed request failures, such as elevated retry rates, increased request latency, or a persistent inability to complete write operations. In other embodiments, external availability signals may include alerts or metrics collected from client-facing services, application monitoring agents, third-party observability tools, or customer-reported incident telemetry. External availability signals may be used in conjunction with internal health indicators to confirm, override, or supplement the system's internal view of replica health. In some implementations, external signals may be used to accelerate detection, reduce false positives, or provide fallback detection in environments where internal telemetry is degraded or unavailable.

In some embodiments, the failure condition corresponds to a condition in which the previously designated write replica remains responsive and participates in applying the state transition in the replicated state machine. In this example, the replica that is currently designated as the write replica can still respond to coordination messages, propose or accept transitions, and assist in finalizing the reassignment of write authority. This type of failure condition may arise, for example, in scenarios where the replica is experiencing degraded performance, intermittent connectivity issues, or is scheduled for removal as part of planned infrastructure changes. In some embodiments, failover under this type of failure condition can proceed with reduced risk of conflict, split-brain behavior, or loss of coordination state. The ability of the previously designated write replica to participate in the transition may allow the system to perform a more controlled or graceful failover.

In some embodiments, the failure condition corresponds to a condition in which the previously designated write replica is unavailable and does not participate in applying the state transition in the replicated state machine. In this example, the replica that was previously designated as the write replica may be unresponsive, unreachable, or otherwise unable to receive or acknowledge transition proposals. This type of failure condition may arise, for example, from abrupt process termination, hardware failure, network isolation, or region-level outages. In some embodiments, the failover manager 202 proceeds with the state transition based on coordination among the remaining replicas, without requiring acknowledgment or involvement from the previously designated write replica. In such cases, the system may rely on quorum-based agreement or some other mechanism to ensure that the state transition is safely committed and that only one replica is recognized as the current write replica.

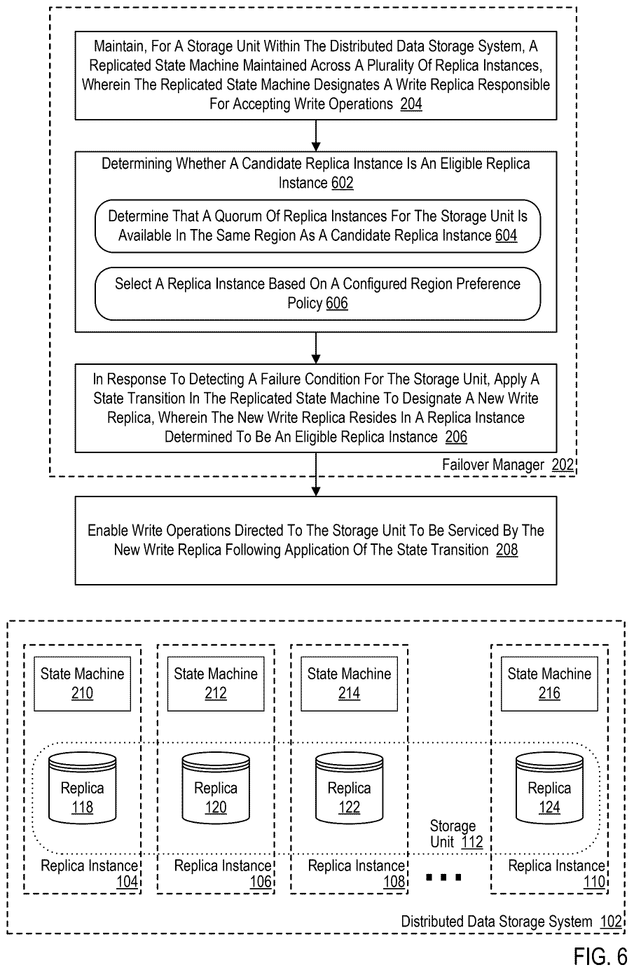

For further explanation, FIG. 6 sets forth a flowchart illustrating an additional example method of managing failover in a distributed data storage system 102 that includes a plurality of storage units 112, 114, 116. As referenced above, as part of a failover process the new write replica resides in a replica instance that has been determined to be an eligible replica instance.

In the example depicted in FIG. 6, determining 602 whether a candidate replica instance is an eligible replica instance can be carried out, at least in part, by determining 604 that a quorum of replicas or replica instances for the storage unit is available in the same region as the candidate replica or replica instance. Determining 604 that a quorum of replicas or replica instances for the storage unit is available in the same region as the candidate replica or replica instance may be carried out, for example, by the failover manager 202 identifying a set of replicas or replica instances that support the storage unit 112 and determining that a sufficient number of those replicas or replica instances are located in the same region as the candidate replica or replica instance. In some embodiments, the determination can include verifying that the replicas or replica instances in the region are healthy, responsive, or otherwise eligible to participate in write operations. In other embodiments, the determination may include evaluating recent heartbeat signals or other telemetry to confirm that the quorum condition is met. The number of replicas or replica instances required to satisfy quorum may be fixed or may vary based on system configuration or replica count.

In the example depicted in FIG. 6, determining 602 whether a candidate replica or replica instance is an eligible replica or replica instance can be carried out, at least in part, by selecting 606 a replica or replica instance based on a configured region preference policy. Selecting 606 a replica or replica instance based on a configured region preference policy may be carried out, for example, by the failover manager 202 evaluating a set of eligible replicas or replica instances and identifying the replica or replica instance located in a region that is ranked most preferred according to a defined policy. In some embodiments, the region preference policy may be defined by administrative configuration, service-level objectives, regulatory requirements, latency optimization goals, or in some other way. The preference policy may be encoded in metadata, configuration files, or even control plane settings that are accessible to the failover manager 202. The region preference policy may be used, for example, to guide replica selection among two or more otherwise eligible candidates. In some embodiments, other criteria may be leveraged as eligibility criteria (e.g., whether the progress and state of a replica is consistent with the customer selected consistency level) that is used when evaluating replicas or replicas instances for eligibility.

In some embodiments, the replicated state machine is maintained across a plurality of replica instances using a distributed coordination protocol. Maintaining the replicated state machine across a plurality of replica instances using a distributed coordination protocol may be carried out, for example, by the replica instances 104, 106, 108, 110 participating in coordination process that ensure that state transitions are applied consistently and in the correct order. In some embodiments, the distributed coordination protocol may include compare and swap operations, message rounds, or other mechanisms that prevent conflicting state transitions from being accepted. In other embodiments, the distributed coordination protocol may implement a consensus protocol such as CAS Paxos or a similar coordination mechanism that is tailored to the requirements of the distributed data storage system 102. The distributed coordination protocol may allow each replica instance to maintain a consistent view of the replicated state machine even in the presence of partial failures or network partitions. In other embodiments, the replicated state machine is maintained across a plurality of replicas using a distributed coordination protocol in a similar manner.

In some embodiments, coordinating agreement on state transitions among replicas 118, 120, 122, 124 may be carried out without direct coordination by the failover manager 202. In one such embodiment, each replica 118, 120, 122, 124 may be configured to independently propose state transitions based on observed failure conditions or loss of quorum. A replica 118, 120, 122, 124 that initiates such a proposal can transmit the proposed transition to the other participating replica. Each replica 118, 120, 122, 124 can evaluate the proposal against its current state and respond with an acceptance or rejection, similar to the process described above. If a majority of the replicas 118, 120, 122, 124 accept the proposed transition, the initiating replica can treat the proposal as accepted and proceed to commit the transition. Committing the transition can include, for example, recording the transition in a replicated store, notifying participating replica instances, or updating a local copy of the replicated state machine. In this embodiment, responsibility for managing agreement on state transitions is distributed among the replicas 118, 120, 122, 124 themselves, and the failover manager 202 may play a reduced or passive role.

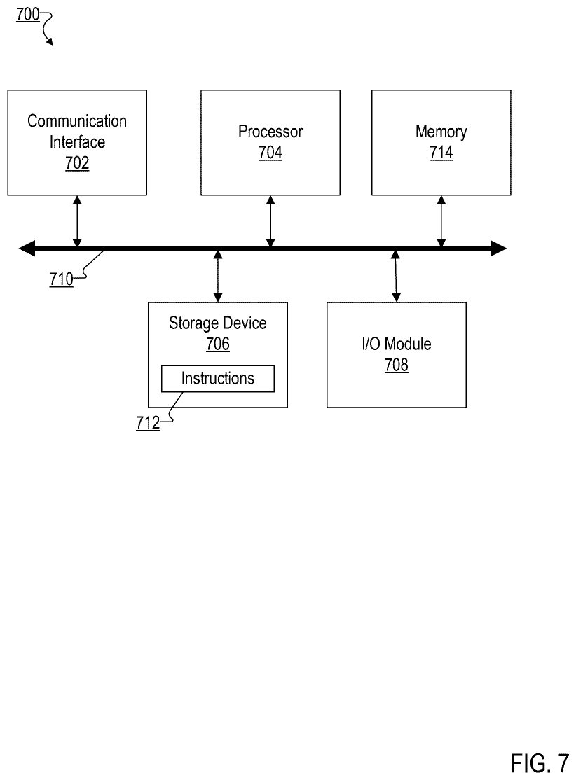

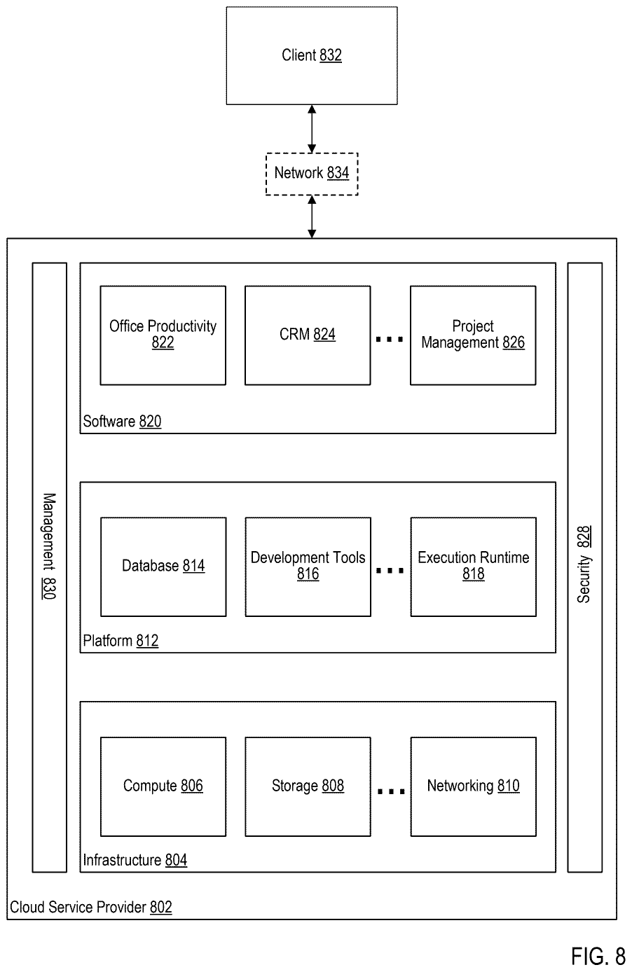

For further explanation, the sections included below provide some details regarding technologies that may be used to support various embodiments. For example, FIG. 7 sets forth an example of a computing device that may be used for some portion of securing an operating system in accordance with some embodiments. As an additional example of technologies that may be used to secure an operating system, FIG. 8 sets forth a block diagram of a cloud service provider 802 service architecture in accordance with some embodiments of the present disclosure.

For further explanation, FIG. 7 illustrates an exemplary computing device 700 that may be specifically configured to perform one or more of the processes described herein. As shown in FIG. 7, computing device 700 may include a communication interface 702, a processor 704, a storage device 706, an input/output (I/O) module 708, and computer memory 714 communicatively connected one to another via a communication infrastructure 710. While an exemplary computing device 700 is shown in FIG. 7, the components illustrated in FIG. 7 are not intended to be limiting. Additional or alternative components may be used in other embodiments. Components of computing device 700 shown in FIG. 7 will now be described in additional detail.

Communication interface 702 may be configured to communicate with one or more computing devices. Examples of communication interface 702 include, without limitation, a wired network interface (such as a network interface card), a wireless network interface (such as a wireless network interface card), a modem, an audio/video connection, and any other suitable interface.

Processor 704 generally represents any type or form of processing unit capable of processing data and/or interpreting, executing, and/or directing execution of one or more of the instructions, processes, and/or operations described herein. Processor 704 may perform operations by executing computer-executable instructions 712 (e.g., an application, software, code, and/or other executable data instance) stored in storage device 706.

Storage device 706 may include one or more data storage media, devices, or configurations and may employ any type, form, and combination of data storage media and/or device. For example, storage device 706 may include, but is not limited to, any combination of non-volatile media and/or volatile media. Electronic data, including data described herein, may be temporarily and/or permanently stored in storage device 706. For example, data representative of computer-executable instructions 712 configured to direct processor 704 to perform any of the operations described herein may be stored within storage device 706. In some examples, data may be arranged in one or more databases residing within storage device 706.

I/O module 708 may include one or more I/O modules configured to receive user input and provide user output. I/O module 708 may include any hardware, firmware, software, or combination thereof supportive of input and output capabilities. For example, I/O module 708 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 708 is configured to provide graphical data to a display for presentation to a user. The graphical data may be representative of one or more graphical user interfaces and/or any other graphical content as may serve a particular implementation. In some examples, any of the systems, computing devices, and/or other components described herein may be implemented by computing device 700.

For further explanation and as an additional example of a supporting technology for the present embodiments, FIG. 8 sets forth a block diagram of a cloud service provider service architecture in accordance with some embodiments. The cloud service provider 802 can deliver a variety resources through a services-based consumption model where resources are consumed on-demand and as-a-service. Cloud service providers can provide services via cloud platforms such as, for example, Microsoft Azure™, Amazon Web Services (‘AWS’)™, Google Cloud Platform (‘GCP’)™, and others. In FIG. 8, the cloud service provider 802 is accessed from a client device 834 via a network 832.

FIG. 8 depicts an embodiment where software 820 is delivered as a service. Software-as-a-service (‘SaaS’) is a model where software applications are delivered over the internet as-a-service. Rather than installing and maintaining software locally, users can access software via a web browser or other network connected interface, eliminating the need for complex software and hardware management on the client-side. In FIG. 8, as examples of software 820 that can be delivered as-a-service, the illustrated embodiment includes office productivity 822 software, customer relationship management (‘CRM’) 824 software, and project management 826 software. The office productivity 822 software can include applications designed to facilitate common business and personal tasks, including word processing applications, applications for spreadsheet creation, presentation design applications, and many others. The CRM 824 software can include applications for managing a business organization's relationships and interactions with customers and potential customers. The project management 826 software can include applications designed to help teams plan, organize, and manage projects efficiently by facilitating collaboration and tracking the progress of projects. Readers will appreciate that in other embodiments, other types of software may be delivered using a SaaS model.

FIG. 8 depicts an embodiment where platforms 812 can be delivered as a service. Platform-as-a-service (‘PaaS’) is a model that provides cloud customers with platform resources that they can use to develop, run, and manage applications without the complexity of such deploying and managing such infrastructure on their own. In FIG. 8, as examples of platform 812 resources that can be delivered as-a-service, the illustrated embodiment includes database 814 services, development tools 816 services, and execution runtime 818 services. The database 814 services can be used to provide access to databases without management overhead for the user as the cloud service provider manages the provisioning, scaling, and maintenance of the databases. The development tools 816 services can provide developers with tools to design, develop, test, and deploy applications without needing to manage the underlying infrastructure. The execution runtime 818 services can provide environments where applications or other forms of computer program code can be executed, including services to scale the execution environment. Readers will appreciate that in other embodiments, other platform resources may be delivered using a PaaS model.

FIG. 8 depicts an embodiment where infrastructure 804 can be delivered as a service. Infrastructure-as-a-Service (‘IaaS’) is a model that provides virtualized computing resources over the internet, such that infrastructure such as servers, storage, networks, and others may be leased on demand rather than purchasing and maintaining physical hardware. In FIG. 8, as examples of infrastructure 804 resources that can be delivered as-a-service, the illustrated embodiment includes compute 806 services, storage 808 services, and networking 810 services. The compute 806 services can be used to provide on-demand access to computational resources such as VMs, containers, and serverless functions, where the cloud service provider manages the provisioning, scaling, and maintenance of such resources. The storage 808 services can provide storage resources that can be used to store and access data, without the need for customers to purchase and manage on-premises physical storage resources. The networking 810 services can provide the ability to create and manage virtualized networking resources such as, for example, virtual private networks (‘VPNs’), firewalls, load balancers, and more. Readers will appreciate that in other embodiments, other infrastructure resources may be delivered using a IaaS model.

The cloud service provider of FIG. 8 also provides management 830 resources. The management 830 resources can include, for example, tools and interfaces that enable customers to efficiently deploy, monitor, and manage, their cloud services. Such tools can include web-based management consoles, command-line interfaces (‘CLIs’), APIs, automation tools, and other tools.

The cloud service provider of FIG. 8 also provides security 828 resources. The security 828 resources can include, for example, tools and services to help customers protect their cloud environments and ensure compliance with security standards. These tools and services may provide specific aspects of security, including identity and access management, network security, threat detection, compliance management, and others.

Readers will appreciate that many of the components described above may be delivered as services from a cloud service provider. For example, the virtual machines, containers, and pods described above may all be delivered via a cloud service provider. In other embodiments, other forms of compute resources may be used in place of the virtual machines or other compute resource. For example, AWS EC2 instances or other form of cloud compute instances may be utilized in place of the virtual machines.

Advantages and features of the present disclosure can be further described by the following statements:
1. A method for managing failover in a distributed data storage system comprising a plurality of storage units, the method comprising: maintaining, for a storage unit within the distributed data storage system, a replicated state machine maintained across a plurality of replica instances, wherein the replicated state machine designates a write replica responsible for accepting write operations; in response to detecting a failure condition for the storage unit, applying a state transition in the replicated state machine to designate a new write replica, wherein the new write replica resides in a replica instance determined to be an eligible replica instance; and enabling write operations directed to the storage unit to be serviced by the new write replica following application of the state transition.
2. The method of any combination of one or more of the statements above wherein applying the state transition in the replicated state machine further comprises coordinating, by a failover manager, agreement on state transitions among a majority of replicas using consistency-preserving mechanisms.
3. The method of any combination of one or more of the statements above wherein applying the state transition in the replicated state machine further comprises initiating, by the failover manager, a proposed state transition for durable recording in a manner that maintains consistency across replicas of the storage unit.
4. The method of any combination of one or more of the statements above further comprising: monitoring internal health indicators of the distributed data storage system; and detecting, based on the internal health indicators, a failure condition for the storage unit.
5. The method of any combination of one or more of the statements above wherein detecting a failure condition for the storage unit further comprises incorporating external availability signals as additional inputs to failure detection.
6. The method of any combination of one or more of the statements above wherein the failure condition corresponds to a condition in which the previously designated write replica remains responsive and participates in applying the state transition in the replicated state machine.
7. The method of any combination of one or more of the statements above wherein the failure condition corresponds to a condition in which the previously designated write replica is unavailable and does not participate in applying the state transition in the replicated state machine.
8. The method of any combination of one or more of the statements above, further comprising determining whether a candidate replica instance is an eligible replica instance, including determining that a quorum of replica instances for the storage unit is available in the same region as a candidate replica instance.
9. The method of any combination of one or more of the statements above, further comprising determining whether a candidate replica instance is an eligible replica instance, including selecting a replica instance based on a configured region preference policy.
10. The method of any combination of one or more of the statements above wherein the replicated state machine is maintained across a plurality of replica instances using a distributed coordination protocol.
11. An apparatus for managing failover in a distributed data storage system comprising a plurality of storage units, comprising: a memory; and one or more processing devices, operatively coupled to the memory, the one or more processing devices configured to: maintain, for a storage unit within the distributed data storage system, a replicated state machine maintained across a plurality of replica instances, wherein the replicated state machine designates a write replica responsible for accepting write operations; in response to detecting a failure condition for the storage unit, apply a state transition in the replicated state machine to designate a new write replica, wherein the new write replica resides in a replica instance determined to be an eligible replica instance; and enable write operations directed to the storage unit to be serviced by the new write replica following application of the state transition.
12. The apparatus of any combination of one or more of the statements above wherein, to apply the state transition in the replicated state machine, the one or more processing devices are further configured to coordinate agreement on state transitions among a majority of replicas using consistency-preserving mechanisms.
13. The apparatus of any combination of one or more of the statements above wherein, to apply the state transition in the replicated state machine, the one or more processing devices are further configured to initiate a proposed state transition for durable recording in a manner that maintains consistency across replicas of the storage unit.
14. The apparatus of any combination of one or more of the statements above wherein the one or more processing devices are further configured to: monitor internal health indicators of the distributed data storage system; and detect, based on the internal health indicators, a failure condition for the storage unit.
15. A non-transitory computer readable storage medium storing instructions which, when executed, cause a processing device to: maintain, for a storage unit within the distributed data storage system, a replicated state machine maintained across a plurality of replica instances, wherein the replicated state machine designates a write replica responsible for accepting write operations; in response to detecting a failure condition for the storage unit, apply a state transition in the replicated state machine to designate a new write replica, wherein the new write replica resides in a replica instance determined to be an eligible replica instance; and enable write operations directed to the storage unit to be serviced by the new write replica following application of the state transition.
16. The non-transitory computer readable storage medium of any combination of one or more of the statements above wherein, to apply the state transition in the replicated state machine, the processing device is further configured to coordinate agreement on state transitions among a majority of replicas using consistency-preserving mechanisms.
17. The non-transitory computer readable storage medium of any combination of one or more of the statements above wherein, to apply the state transition in the replicated state machine, the processing device is further configured to initiate a proposed state transition for durable recording in a manner that maintains consistency across replicas of the storage unit.
18. The non-transitory computer readable storage medium of any combination of one or more of the statements above wherein the processing device is further configured to: monitor internal health indicators of the distributed data storage system; and detect, based on the internal health indicators, a failure condition for the storage unit.
19. The non-transitory computer readable storage medium of any combination of one or more of the statements above wherein the processing device is further configured to determine whether a candidate replica instance is an eligible replica instance, including determining that a quorum of replica instances for the storage unit is available in the same region as a candidate replica instance.
20. The non-transitory computer readable storage medium of any combination of one or more of the statements above wherein the processing device is further configured to determine whether a candidate replica instance is an eligible replica instance, including selecting a replica instance based on a configured region preference policy.

Although some embodiments are described largely in the context of a system, method, or in some other way, readers will recognize that embodiments of the present disclosure may also take the form of a computer program product disposed upon computer readable storage media for use with any suitable processing system. Such computer readable storage media may be any storage medium for machine-readable information, including magnetic media, optical media, solid-state media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps described herein as embodied in a computer program product. Persons skilled in the art will recognize also that, although some of the embodiments described in this specification are oriented to software installed and executing on computer hardware, nevertheless, alternative embodiments implemented as firmware or as hardware are well within the scope of the present disclosure.

Readers will appreciate that some embodiments are described in which computer program instructions are executed on computer hardware such as, for example, one or more computer processors. Readers will appreciate that in other embodiments, computer program instructions may be executed on virtualized computer hardware (e.g., one or more virtual machines), in one or more containers, in one or more cloud computing instances (e.g., one or more AWS EC2 instances), in one or more serverless compute instances offered such as those offered by a cloud service provider, in one or more event-driven compute services such as those offered by a cloud service provider, or in some other execution environment.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the one or more embodiments are expressly described herein, other combinations of these features and functions are likewise possible. The present disclosure is not limited by the particular examples disclosed herein and expressly incorporates these other combinations.

What is claimed is:

1. A method for managing failover in a distributed data storage system comprising a plurality of storage units, the method comprising:
maintaining, for a storage unit within the distributed data storage system, a replicated state machine maintained across a plurality of replica instances, wherein the replicated state machine designates a write replica responsible for accepting write operations;
in response to detecting a failure condition for the storage unit, applying a state transition in the replicated state machine to designate a new write replica, wherein the new write replica resides in a replica instance determined to be an eligible replica instance; and
enabling write operations directed to the storage unit to be serviced by the new write replica following application of the state transition.

2. The method of claim 1 wherein applying the state transition in the replicated state machine further comprises coordinating, by a failover manager, agreement on state transitions among a majority of replicas using consistency-preserving mechanisms.

3. The method of claim 1 wherein applying the state transition in the replicated state machine further comprises initiating, by the failover manager, a proposed state transition for durable recording in a manner that maintains consistency across replicas of the storage unit.

4. The method of claim 1 further comprising:
monitoring internal health indicators of the distributed data storage system; and
detecting, based on the internal health indicators, a failure condition for the storage unit.

5. The method of claim 4 wherein detecting a failure condition for the storage unit further comprises incorporating external availability signals as additional inputs to failure detection.

6. The method of claim 1 wherein the failure condition corresponds to a condition in which a previously designated write replica remains responsive and participates in applying the state transition in the replicated state machine.

7. The method of claim 1 wherein the failure condition corresponds to a condition in which a previously designated write replica is unavailable and does not participate in applying the state transition in the replicated state machine.

8. The method of claim 1, further comprising determining whether a candidate replica instance is an eligible replica instance, including determining that a quorum of replica instances for the storage unit is available in a same region as a candidate replica instance.

9. The method of claim 1, further comprising determining whether a candidate replica instance is an eligible replica instance, including selecting a replica instance based on a configured region preference policy.

10. The method of claim 1 wherein the replicated state machine is maintained across a plurality of replica instances using a distributed coordination protocol.

11. An apparatus for managing failover in a distributed data storage system comprising a plurality of storage units, comprising:
a memory; and
one or more processing devices, operatively coupled to the memory, the one or more processing devices configured to:
maintain, for a storage unit within the distributed data storage system, a replicated state machine maintained across a plurality of replica instances, wherein the replicated state machine designates a write replica responsible for accepting write operations;
in response to detecting a failure condition for the storage unit, apply a state transition in the replicated state machine to designate a new write replica, wherein the new write replica resides in a replica instance determined to be an eligible replica instance; and
enable write operations directed to the storage unit to be serviced by the new write replica following application of the state transition.

12. The apparatus of claim 11 wherein, to apply the state transition in the replicated state machine, the one or more processing devices are further configured to coordinate agreement on state transitions among a majority of replicas using consistency-preserving mechanisms.

13. The apparatus of claim 11 wherein, to apply the state transition in the replicated state machine, the one or more processing devices are further configured to initiate a proposed state transition for durable recording in a manner that maintains consistency across replicas of the storage unit.

14. The apparatus of claim 11 wherein the one or more processing devices are further configured to:
monitor internal health indicators of the distributed data storage system; and
detect, based on the internal health indicators, a failure condition for the storage unit.

15. A non-transitory computer readable storage medium storing instructions which, when executed, cause a processing device to:
maintain, for a storage unit within a distributed data storage system, a replicated state machine maintained across a plurality of replica instances, wherein the replicated state machine designates a write replica responsible for accepting write operations;
in response to detecting a failure condition for the storage unit, apply a state transition in the replicated state machine to designate a new write replica, wherein the new write replica resides in a replica instance determined to be an eligible replica instance; and
enable write operations directed to the storage unit to be serviced by the new write replica following application of the state transition.

16. The non-transitory computer readable storage medium of claim 15 wherein, to apply the state transition in the replicated state machine, the processing device is further configured to coordinate agreement on state transitions among a majority of replicas using consistency-preserving mechanisms.

17. The non-transitory computer readable storage medium of claim 15 wherein, to apply the state transition in the replicated state machine, the processing device is further configured to initiate a proposed state transition for durable recording in a manner that maintains consistency across replicas of the storage unit.

18. The non-transitory computer readable storage medium of claim 15 wherein the processing device is further configured to:
monitor internal health indicators of the distributed data storage system; and
detect, based on the internal health indicators, a failure condition for the storage unit.

19. The non-transitory computer readable storage medium of claim 15 wherein the processing device is further configured to determine whether a candidate replica instance is an eligible replica instance, including determining that a quorum of replica instances for the storage unit is available in a same region as a candidate replica instance.

20. The non-transitory computer readable storage medium of claim 15 wherein the processing device is further configured to determine whether a candidate replica instance is an eligible replica instance, including selecting a replica instance based on a configured region preference policy.
